(19) United States
(12) Patent Application Publication
(10) Pub. No.: US 2015/0071198 A1
(43) Pub. Date: Mar. 12, 2015

(54) METHOD OF RANDOMLY ACCESSING A SECONDARY CELL AND RECEIVING DATA

(71) Applicant: Alcatel Lucent, Boulogne Billancourt (FR)

(72) Inventor: Yun Deng, Shanghai (CN)

(21) Appl. No.: 14/385,950

(22) PCT Filed: Mar. 18, 2013
(86) PCT No.: PCT/IB2013/000597

§ 371 Date: Sep. 17, 2014

(30) Foreign Application Priority Data
Mar. 19, 2012 (CN) 201210074087.8

(51) Int. Cl. H04W 74/00

(52) U.S. Cl. CPC H04W 74/006
USPC 370/329

(57) ABSTRACT

The existing technology focuses on the case of the same timing advance (TA) in carrier aggregation, not supporting randomly accessing a SCell in the multi-TA carrier aggregation. The invention provides a method of randomly accessing a SCell and receiving data. For a procedure of randomly accessing a secondary cell (SCell), the UE has accessed a primary cell (PCell), the PCell and the SCell belong to different timing advance groups, the first cell transmits (A, A′, B) a random access command to the UE, the command is used for instructing the UE to access the SCell; According to the random access command, the UE transmits (C) a random access preamble to the SCell. Preferably, the first cell comprises another cell which cross-carrier schedules the SCell or the SCell. The invention provides a technical solution of randomly accessing a SCell in a multi-TA scenario, which fills the gaps in the existing technology.

### TECHNICAL FIELD

The invention relates to the random access of the wireless communication field, and especially relates to the random access in the case of multiple cells carrier aggregation.

### BACKGROUND TECHNOLOGY

In order to support high data rates, carrier aggregation is introduced in LTE-A release 10 (R10). In carrier aggregation, more than two (including two) component carriers can be aggregated to one UE. In R10, there is such a restriction to component carriers that these component carriers have the same timing advance (TA). The timing advance is used to ensure that uplink data transmitted by different UEs to an eNB can be synchronous when arrive at the eNB. In release 11 (R11), in order to support more flexible deployments for operators, the industry suggests to eliminate this restriction. Therefore, multi-TA can be supported in R11 if the UE have the corresponding function. Serving cells (typically the serving cells are administrated by the same transmitter) having the uplinks, to which the same TA and the same timing reference apply, are grouped in the same TA group (TAG for short). Each TA group contains at least one serving cell with configured uplink, and the corresponding relationship of each serving cell with the TA group to which it belongs is configured to the UE by a serving eNB with RRC signaling. The UE should access a primary cell (or called as PCell). The corresponding relationship between a secondary cell (called as SCell) and a TA group may be reconfigured with RRC signaling. A UE supporting multi-TA needs to support at least two TA groups, i.e., the TA group (pTAG) containing a PCell, whose identification is 0, and the TA group (sTAG) not containing the PCell.

In order to obtain the timing advance corresponding to a sTAG, random access procedure initiated by the eNB should be used, and the eNB initiates a non-contention based random access procedure for an activated SCell only via downlink control information (DCI) transported over a PDCCH (or called as Physical Downlink Control Channel). According to current TS36.212 standard, if DCI 1A is used to trigger a non-contention based random access procedure, the corresponding information element (IE for short) in DCI 1A should meet the following requirements:
localized/distributed VRB (Virtual Resource Block) assignment flag—1 bit, which is set to 0;
resource block assignment—several bits, all bits are set to 1;
preamble index—6 bits;
PRACH (Physical Random Access Channel) mask index—4 bits,
All the remaining bits in format 1A and used for compact scheduling assignment of single PDSCH (Physical Downlink Shared Channel) codeword are set to zero.

We can find that, the DCI 1A doesn't contain the information for triggering a random access procedure in a SCell, therefore it can not support a random access procedure in a SCell.

In addition, in a random access procedure, once a UE performs a random access procedure in a SCell, it should monitor the random access response (RAR for short, or called as MSG2) of random access. MSG2 may be addressed by a random access radio network temporary identifier (RA-RNTI). In the current TS 36.213 standard, the UE can not receive data from pTAG and other sTAG when monitoring a MSG2, this is because that when the DCI scrambled by a RA-RNTI is assigned in a certain subframe, the DCI scrambled by a C-RNTI (Cell Radio Network Temporary Identifier) or SPS C-RNTI (Semi-Persistent Scheduling C-RNTI) is also assigned in the subframe, and after detecting the DCI scrambled by a RA-RNTI, the UE will not decode the DCI, scrambled by a C-RNTI or SPS-RNTI, transmitted by the cells belonging to a pTAG or other sTAG any more, therefore the UE will not receive and decode the data transported in a PDSCH and indicated by these DCIs. This leads to a decrease in communication performance.

The current standard and solution focus on the case of the same timing advance in carrier aggregation. Thus the current solution can not support the problem of SCell random access and the data receiving problem in a random access procedure under multi-TA carrier aggregation.

### SUMMARY OF THE INVENTION

The invention intends to provide a random access solution for a SCell in a multi-TA carrier aggregation scenario, and to provide a technical solution of solving data receiving problem for another cell during the random access procedure of a SCell in a multi-TA carrier aggregation scenario.

According to one aspect of the invention, a method is provided in a UE used for randomly accessing a secondary cell, wherein the UE has accessed a primary cell, the primary cell and the secondary cell belong to different timing advance groups. The method comprises the following steps:
a. receiving a random access command from the first cell, the command is used for instructing the UE to access the secondary cell;
b. transmitting a random access preamble to the secondary cell, according to the random access command.

The aspect provides a technical solution for a UE accessing a SCell in a multi-TA scenario, which fills the blanks in the existing technology.

According to an embodiment of the aspect, in the step a, the received random access command is any one of the following:
downlink control information 1A instructing random access, which comprises instruction information instructing accessing secondary cells;
downlink control information dedicated for instructing randomly accessing secondary cells.

The embodiment provides a solution of using DCI as a random access command. Wherein, when using DCI 1A as a random access command, it has better backward compatibility.

According to a further preferable embodiment, when the random access command is the downlink control information 1A instructing random access, the instruction information comprises any of the following fields that are configured as specific values used for instructing randomly accessing a secondary cell:
a carrier indicator;
a dedicated information element;
an information element of modulation and coding scheme;
an information element of HARQ procedure number.

This further preferable embodiment provides the available fields which can be used for instructing randomly accessing a SCell, when using DCI 1A as a random access command. When using the fields such as the current carrier indicator, the information element of modulation and coding scheme and the information element of HARQ procedure number etc., it has better backward compatibility.

According to an embodiment of the aspect, the secondary cell is configured with cross-carrier scheduling by a base station, the random access command further comprises indication information indicating the secondary cell, and

in the step a, another cell that cross-carrier schedules the secondary cell is the first cell, and the random access command is transmitted by the another cell.

In this embodiment, it allows cross-carrier scheduling, and randomly accessing a SCell may be initiated by a PCell or another SCell of different TA group of the PCell, which provides a great flexibility for random access control. Specially, in the case of using DCI 1A as the random access command, the indication information indicating the SCell may be implemented by the carrier indicator in DCI 1A, and the carrier indicator indicates the serving cell index of the SCell.

According to another embodiment of the aspect, the secondary cell is not configured with cross-carrier scheduling by a base station, in the step a, the secondary cell is taken as the first cell to transmit the random access command, and the random access command is transmitted by the secondary cell.

In the embodiment, randomly accessing a SCell is triggered by the random access command transmitted by the SCell, which can directly control random access well.

According to an embodiment of the aspect, the step a obtains preamble information and mask information of a physical random access channel from the command, and

the step b transmits the preamble to the secondary cell to request random access, according to a configuration of the physical random access channel.

The embodiment provides a more specific implementation of requesting random access.

According to an embodiment of the aspect, before the step b, the method further comprises the following steps:
verifying if the random access command is valid; and

implementing the step b when the validity of the command is verified.

Since the random access command may be transmitted in error, or the first cell implements a wrong scheduling to generate an error random access command, the random access command received by the UE may be invalid, which affects randomly accessing a SCell. Thus, before implementing random access request, the UE preferably first verifies if the random access command is valid, which makes the method, according to the invention, of randomly accessing a SCell with strong robustness.

According to a further preferable embodiment, the method further comprises the following steps:
determining the timing advance groups to which the primary cell and each of secondary cells respectively belong;

verifying that the random access command is valid comprises:
determining that the timing advance group to which the secondary cell belongs is different from the timing advance group of the primary cell;
determining that the secondary cell is activated;
determining that the preamble is a dedicated random access preamble, and the physical random access channel is valid.

The embodiment provides a more specific way of verifying if the random access command is valid.

According to the above first aspect and each embodiment, a preferable implementation solution of the invention is:

A serving eNB can use DCI 1A to trigger randomly accessing a SCell, and the carrier indicator IE is used to indicate a SCell index.

After the UE receives the DCI 1A, it will verify the instruction, and check if it can implement random access in the designated SCell. Only when the following conditions are all met, the UE can implement random access normally:
1. The SCell belongs to a sTAG different from a PSell;
2. The SCell has been activated;
3. DCI 1A comprises a valid preamble to trigger a non-contention based random access procedure.

According to a second aspect corresponding to the above first aspect of the invention in a cell, a method used for instructing a UE to randomly access a secondary cell, in a base station to which the first cell belongs, is provided. The UE has accessed a primary cell, the primary cell and the secondary cell belong to different timing advance groups, and the method comprises the following steps:
c. transmitting a random access command to the UE, the command is used for instructing the UE to access the secondary cell.

Preferably, the step c puts indication information indicating the secondary cell in the random access command for transmitting; and/or,
the first cell comprises any cell of the following:
the secondary cell;
the primary cell;
another cell that cross-carrier schedules the secondary cell.

This preferable embodiment provides the implementation of the invention in a cell in the case of cross-carrier scheduling and non cross-carrier scheduling.

According to a third aspect of the invention, a method of receiving data in a UE is provided. The UE has accessed a primary cell, and is randomly accessing a secondary cell, the secondary cell and the primary cell belong to different timing advance groups, and the method comprises the following steps:
i. receiving a random access response from the secondary cell in a certain subframe;
ii. continuing receiving and decoding a physical downlink channel transmitted by other cells in the subframe.

In this aspect, in the case of receiving the random access response of a SCell, the UE continues to receive and decode a physical downlink channel transmitted by another cell, which solves the data losing problem existing in the current standard.

Preferably, the other cells comprise:
the primary cell; and/or
other secondary cells belong to the same timing advance groups with the primary cell; and/or
other cells belong to different timing advance groups with the secondary cell.

Preferably, in the step i, the random access response is scrambled by a random access RNTI; and
in the step ii,
the UE needs decoding, in PDCCH, downlink control information scrambled by the UE's C-RNTI, and/or
decoding, in PDCCH of a primary cell, downlink control information scrambled by the UE's semi-persistent scheduling RNTI, and/or
decoding, in PDSCH of a primary cell, the data information scrambled by the UE's semi-persistent scheduling RNTI.

According to the above third aspect and each embodiment, a preferable implementation of the invention is:

When the UE receives MSG2 (random access response) associated with a SCell in a certain subframe, the UE further decodes downlink control information addressed (scrambled) by C-RNTI/SPS C-RNTI, in the PDCCH of another cell, and the another cell may a PCell or SCell belonging to a pTAG, or another SCell belonging to sTAG.

In addition, during the UE performs random access to the PCell due to the reason of link failure, etc., the UE only monitors the PDCCH in a PCell. When the UE receives MSG2 associated with a PCell in a certain subframe, the UE no longer decodes downlink control information scrambled by C-RNTI/SPS C-RNTI, in PDCCH of a PCell (including another cell).

### BRIEF DESCRIPTION OF DRAWINGS

By reading the detailed description of specific embodiment referring to the following drawings, other features, purposes and advantages of the invention will become clearer:

FIG. 1 is a schematic diagram according to an embodiment of the invention.

### DETAILED EMBODIMENT

The following will elucidate the invention in detail through describing several embodiments. It should be understood that, in the case of non-conflict, some embodiments and their features may be combined with other embodiments and their features to generate new embodiments.

### Embodiment 1

A UE has accessed a PCell, and set up a RRC (Radio Resource Control) connection with a serving eNB. The serving eNB configures C-RNTI for the UE, optionally, further including SPS C-RNTI. Due to the service requirement (e.g. the increase of throughput), the serving eNB needs to configure for the UE another serving cell called a SCell (comprising downlink and uplink). The SCell (the cell index is 1) belongs to a sTAG, the timing advance of the sTAG is different from the timing advance used by the pTAG to which the PCell belongs. The eNB configures, through RRC signaling, that the SCell belongs to the sTAG.

After being aware that the SCell belongs to the sTAG, the UE knows that it needs to perform random access on the SCell to obtain an uplink timing advance.

Before controlling the UE to randomly access the SCell, the serving eNB should activate the SCell. The eNB informs the UE to activate the SCell through a MAC CE (Medium Access Control Control Element).

In the embodiment, the SCell is configured with cross-carrier scheduling by the eNB, thus randomly accessing the SCell can be initiated by another cell which cross-carrier schedules the cell. The another cell is for example:
The PCell;
A SCell belonging to the same pTAG with the PCell;
A SCell belonging to different sTAG with the SCell.

In the embodiment, it takes an example that the random access command is triggered by the PCell to describe the embodiment of invention.

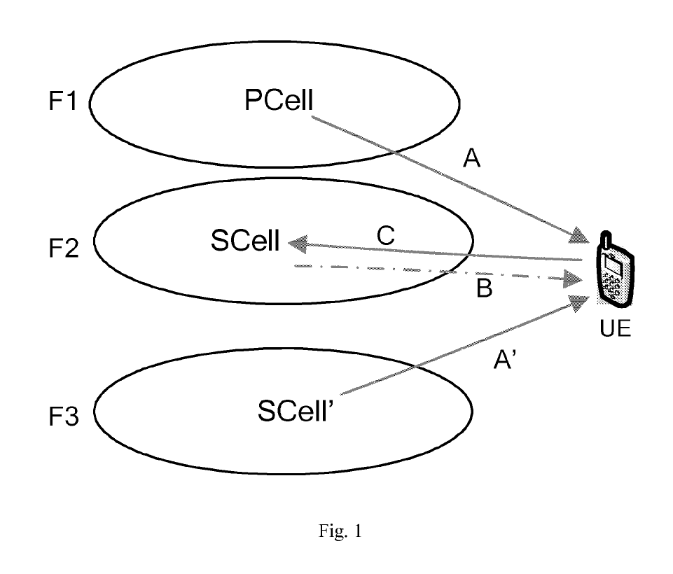

In an embodiment, the PCell cross-carrier schedules the SCell. When triggering the UE to randomly access the SCell, the PCell transmits a random access command to the UE in a PDCCH, illustrated as the arrow A in FIG. 1. Wherein, the band (comprising uplink and downlink) occupied by the PCell is F1 (It needs to explain that, for TDD the center frequency of uplink and downlink are F1. For FDD, the center frequency of uplink and downlink are different, e.g. uplink is F1−, downlink is F1+, here taking F1 to indicate uplink and downlink. The other places in the present application indicating frequency all apply this explanation). The UE detects downlink control information transmitted by the PCell in the PDCCH, and receives the random access command.

In a detailed embodiment, the random access command is downlink control information 1A (DCI 1A). When the carrier indicator of DCI 1A is 0, it's used for instructing randomly accessing the PCell itself; while when the carrier indicator of DCI 1A is 1, it can be used for instructing randomly accessing the SCell. The PCell transmits the UE DCI 1A with the carrier indicator valued 1, the DCI 1A still comprises a preamble index used for performing random access and a PRACH mask index. The PRACH mask index is used for indicating the allowed PRACH (Physical Random Access Channel).

Since DCI 1A is transmitted in a PDCCH, there might be a certain error probability; or the PCell may schedule mistakenly, e.g. allocating a preamble that has been allocated as a public preamble to be used in random access, and these errors lead that errors occur in random access. Thus, after receiving DCI 1A, and before performing random access, preferably, the UE verifies if the random access command is valid. In detail, the UE determines that the timing advance group to which the SCell belongs isn't a pTAG; determines that the SCell has been activated; also determines that the preamble is valid, e.g. not occupied by a public preamble (the UE may obtain the public preambles through a system message, then may determine if the preamble indicated in DCI 1A is a public preamble, if not the public preamble, determining valid); also determines that PRACH mask is valid. In the case that the random access command is valid, the UE performs random access. It may be understood that, the verification step performs fault tolerance processing against DCI transmission error or PCell scheduling error, and they are not necessary steps to implement the invention.

When randomly accessing, according to the PRACH configuration, the UE transmits a preamble to a SCell (transmitting in uplink), i.e. transmitting to the serving eNB of a SCell, to perform random access request, illustrated as the arrow C in FIG. 1. Wherein, the band occupied by the SCell (comprising uplink and downlink) is F2. It may be understood that, the difference of a PCell and a SCell in FIG. 1 is to explain that they are different cells logically, while physically, they may be controlled respectively by different transmitters in the same serving eNB.

According to the time-frequency location for transmitting the random access preamble, the UE calculates to obtain the RA-RNTI for the random access process.

Later, the UE continuously monitors the random access response MSG2 scrambled by the RA-RNTI, transmitted by the serving eNB administrating the SCell. In this duration, the UE also monitors the DCI scrambled by C-RNTI and/or SPS C-RNTI, transmitted in the PCell PDCCH. In a certain subframe, when the UE receives the random access response MSG2 scrambled by RA-RNTI, in this subframe, the UE keeps decoding, in PCell PDCCH, downlink control information scrambled by the UE C-RNTI (if there is other SCell in the pTAG, or other SCell belonging to other sTAG, the UE needs to decode, in these SCell PDCCH, downlink control information scrambled by the UE C-RNTI), and/or,
decodes, in the PCell PDCCH, the downlink control information scrambled by the UE SPS C-RNTI, and/or,
decodes, in the PCell PDSCH, the data information scrambled by the UE SPS C-RNTI.

### Embodiment 2

The UE sets up a RRC connection with a serving eNB. It's configured with one pTAG and two sTAGs (sTAG1 and sTAG2). And, the UE has accessed a PCell in the pTAG and a SCell′ in the sTAG1, and obtained each uplink timing advance of the pTAG and the sTAG1.

The serving eNB activates the SCell belonging to the sTAG2, and needs the UE to access the SCell.

In the case that cross-carrier scheduling exists, if it is configured that the PCell cross-carrier schedules the SCell, the PCell may transmit the random access command accessing the SCell to the UE, which is similar with the embodiment 1, illustrated as the arrow A in FIG. 1, wherein, the band occupied by the PCell (comprising uplink and downlink) is F1. If it is configured that the SCell′ cross-carrier schedules the SCell, the SCell′ in the sTAG1 may transmit the random access command to the UE, illustrated as the arrow A′ in FIG. 1, wherein, the band occupied by the SCell′ (comprising uplink and downlink) is F3. The format of random access command may be similar with the one in previous embodiment, e.g. the random access command is DCI 1A, which comprises the carrier indicator to indicate the cell index 1 of a SCell.

While in this embodiment, the SCell is not configured by the eNB with cross-carrier scheduling, then the SCell transmits (for FDD, in the downlink carrier of the SCell; for TDD, in the downlink subframe of the SCell) the random access command to the UE, the command may instruct randomly accessing the SCell, illustrated as the arrow B in FIG. 1. And, the UE knows there is no cross-carrier scheduling, then the UE may determine the SCell transmitting random access command and take it as the target SCell of random access.

Later, the UE can verify the validity of the random access command, and continue randomly accessing when the command is valid, which is similar with previous embodiment.

When randomly accessing, according to the PRACH configuration, the UE transmits a preamble to the SCell (for FDD, transmitting in the uplink carrier of the SCell; for TDD, transmitting in the uplink subframe of the SCell), i.e. transmitting to the serving eNB administrating the SCell, to perform random access request, illustrated as the arrow C in FIG. 1, Wherein, the band occupied by the SCell (comprising uplink and downlink) is F2.

And, according to the time-frequency location for transmitting the random access preamble, the UE calculates to obtain the RA-RNTI for the random access process.

Later, the UE continuously monitors the random access response MSG2 scrambled by RA-RNTI, transmitted by the serving eNB administrating the SCell. In this duration, the UE also monitors the DCI scrambled by C-RNTI and/or SPS C-RNTI, transmitted in the PCell PDCCH, and the DCI scrambled by C-RNTI, transmitted in the PDCCH of a SCell in the sTAG1. In a certain subframe, when the UE receives the random access response MSG2 scrambled by RA-RNTI, in this subframe, the UE still monitors and decodes the DCI scrambled by C-RNTI and/or SPS C-RNTI (optional), transmitted in the PCell PDCCH; in this subframe the UE still monitors and decodes the DCI scrambled by C-RNTI, transmitted in the PDCCH of a SCell in the sTAG1, and obtains downlink data by receiving and decoding corresponding PDSCH according to the DCI information.

When the UE performs random access to the PCell due to the reason of link failure, etc., the UE only monitors the PDCCH in a PCell. When the UE receives the MSG2 associated with the PCell in a certain subframe, the UE no longer decodes the DCI scrambled by C-RNTI/SPS C-RNTI.

There are other implementations of the embodiment: after the UE initiates random access in the SCell, the random access response monitored in the SCell is scrambled by C-RNTI. Here the UE needs to monitor the DCI scrambled by C-RNTI and/or SPS C-RNTI, transmitted in the PCell PDCCH, and the DCI scrambled by C-RNTI, transmitted in the PDCCH of a SCell in the sTAG1.

### Embodiment 3

In the previous two embodiments, in order to exemplify the detailed embodiment of the random access command of a random access SCell, it uses the DCI 1A and the carrier indicator indicating the cell index of a SCell. In a varied embodiment, the carrier indicator may be not used to indicate the cell index of a random access SCell, while a new designed dedicated information element is used to indicate the random access SCell, e.g. indicating its cell index.

In another varied embodiment, there is no need for instructing the index of the SCell randomly accessed, but only need for informing the UE of randomly ac cess a SCell, and the specific SCell to be accessed is determined by the UE itself. E.g. the carrier indicator is set to other specific value other than 0, such as 1 (1 bit) or 111 (3 bits), to represent that the DCI 1A is used for instructing randomly accessing SCell. Or, other information element in the DCI 1A, e.g. the modulation and coding scheme is set to 11111 or the HARQ procedure number is set to 111 to instruct randomly accessing a SCell.

When the UE determines which SCell to randomly access, it may apply the following manners:

In the case that cross-carrier scheduling exists, the corresponding relationship of cross-carrier scheduling has been configured to the UE, and the UE directly finds the cross-carrier scheduled cell, corresponding to the cell transmitting the random access command, as the SCell, according to the relationship of cross-carrier scheduling.

In the case of no cross-carrier scheduling, it is defaulted in the UE that, the SCell, to which the received command belongs, is the SCell for which random access is needed to be performed.

In an alternative embodiment, a serving cell only triggers the UE performing random access for one SCell at a time. The UE determines the SCell that has just been triggered as the SCell to be accessed.

In an alternative embodiment, a serving eNB does not use the current DCI 1A to trigger the UE performing random access in a SCell, and the current DCI 1A is dedicated for triggering the UE performing random access in a PCell. A new DCI is introduced for triggering the UE performing random access in a SCell. The new DCI needs to comprise a random access preamble index and a PRACH mask index, optionally, still may comprise the cell index of the SCell.

After determining the SCell, the UE verifies if the random access command is valid, e.g. the UE determines that the timing advance group to which the SCell belongs is not a pTAG; determines that the SCell has been activated; also determines that the preamble is valid, e.g. not occupied by a public preamble; also determines that PRACH mask is valid. After verifying that the random access command is valid, the UE performs random access.

Certainly, there are other multiple embodiments of the invention. Without departing from the spirit and essence of the invention, the those skilled in the art may make all kinds of corresponding changes and modification according to the invention, while the corresponding changes and modification should belong to the protect scope of the claims appended in the invention.

Those skilled in the art may understand all or partial steps in the above methods may be implemented through programs instructing related hardware, the programs may be stored in readable storage medium of a computer, e.g. a read-only memory, disk or CD-ROM etc. Optionally, all or partial steps in the above embodiments may use one or multiple integrated circuits to implement. Correspondingly, each module/unit in the above embodiments may take either the hardware form to implement, or the form of software function module to implement. The invention isn't limited to any specific forms of combination of hardware and software.

1. A method in a UE used for randomly accessing a secondary cell, wherein the UE has accessed a primary cell, and the primary cell and the secondary cell belong to different timing advance groups, the method comprising:
receiving a random access command from the first cell, the command being used for instructing the UE to access the secondary cell;
transmitting a random access preamble to the secondary cell, according to the random access command.

2. A method of claim 1, wherein, in the receiving, the received random access command is any one of the followings:
downlink control information 1A instructing random access, which comprises instruction information instructing accessing secondary cells;
downlink control information dedicated for instructing randomly accessing secondary cells.

3. A method of claim 2, wherein, when the random access command is the downlink control information 1A instructing random access, the instruction information comprises any of the following fields that are configured with specific values used for instructing randomly accessing secondary cells:
a carrier indicator;
a dedicated information element;
an information element of modulation and coding scheme;
an information element of HARQ procedure number.

4. A method of claim 1, wherein, the secondary cell is configured with cross-carrier scheduling by a base station, the random access command further comprises indication information indicating the secondary cell, and
in the receiving, another cell that cross-carrier schedules the secondary cell is the first cell, and the random access command is transmitted by the another cell.

5. A method of claim 1, wherein, the secondary cell is not configured with cross-carrier scheduling by a base station, and
in the receiving, the secondary cell is taken as the first cell to transmit the random access command, and the random access command is transmitted by the secondary cell.

6. A method of claim 1, wherein, the receivinq obtains preamble information and mask information of a physical random access channel from the command, and
the transmitting transmits the preamble to the secondary cell to request random access, according to a configuration of the physical random access channel.

7. A method of claim 1, before the transmitting, further comprising:
verifying if the random access command is valid; and
implementing the transmitting when the validity of the command is verified.

8. A method of claim 7, further comprising:
determining the timing advance groups to which the primary cell and each of secondary cells respectively belong;
verifying that the random access command is valid comprises:
determining that the timing advance group to which the secondary cell belongs is different from the timing advance group of the primary cell;
determining that the secondary cell is activated; and
determining that the preamble is a dedicated random access preamble, and the physical random access channel is valid.

9. A method used for instructing a UE to randomly access a secondary cell, in a base station to which the first cell belongs, wherein the UE has accessed a primary cell, and the primary cell and the secondary cell belong to different timing advance groups, the method comprising:
transmitting a random access command to the UE, the command is used for instructing the UE to access the secondary cell.

10. A method of claim 9, wherein, the transmitting a random access command to the UE puts indication information indicating the secondary cell in the random access command for transmitting; and/or,
the first cell comprises any cell of the following:
the secondary cell;
the primary cell;
another cell that cross-carrier schedules the secondary cell.

11. A method of receiving data in a UE, wherein the UE has accessed a primary cell, and is randomly accessing a secondary cell, and the secondary cell and the primary cell belong to different timing advance groups, the method comprising:
receiving a random access response from the secondary cell in a certain subframe;
continuing receiving and decoding a physical downlink channel transmitted by other cells in the subframe.

12. A method of claim 11, wherein, in the continuing, the other cells comprise:
the primary cell; and/or
other secondary cells belong to the same timing advance groups with the primary cell; and/or
other cells belong to different timing advance groups with the secondary cell.

13. A method of claim 12, wherein, in the receiving a random access response from the secondary cell in a certain subframe, the random access response is scrambled by a random access RNTI; and
in the continuing,
the UE needs decoding, in PDCCH, downlink control information scrambled by the UE's C-RNTI, and/or
decoding, in PDCCH of a primary cell, downlink control information scrambled by the UE's semi-persistent scheduling RNTI, and/or
decoding, in PDSCH of a primary cell, the data information scrambled by the UE's semi-persistent scheduling RNTI.
